(19) United States
(12) Patent Application Publication
(10) Pub. No.: US 2008/0217546 A1
(43) Pub. Date: Sep. 11, 2008

(54) Pixel Implemented Current to Frequency Converter

(75) Inventors: Roger Steadman, Aachen (DE); Gereon Vogtmeier, Aachen (DE); Michael Gnade, Duisburg (DE); Armin Kemna, Duisburg (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N.V., Eindhoven (NL)

(21) Appl. No.: 11/813,215

(22) PCT Filed: Dec. 19, 2005
(86) PCT No.: PCT/IB05/54298

§ 371 Date: Jul. 2, 2007

(30) Foreign Application Priority Data
Jan. 6, 2005 (EP) 05100059.4

(51) Int. Cl. G01T 1/24

(52) U.S. Cl. 250/370.09; 250/370.08

(57) ABSTRACT

The present invention provides a radiation sensor (104) that has a plurality of sensor elements, wherein each sensor element has a photoelectric detection portion and an integrated current to frequency converter for a built-in analog digital conversion of an acquired analog signal being indicative of an intensity of electromagnetic radiation impinging on the photoelectric detection part. Typically, the detector element corresponds to a pixel of a light detector, such as a photodiode. Preferably, the current to frequency converter as well as the photoelectric conversion portion are arranged besides one another on a common substrate and are implemented on the basis of CMOS technology allowing for a costs efficient mass production of the radiation sensor.

The present invention relates to the field of radiation detection and in particular without limitation to detection of X-rays.

Detection of X-rays is a key technology for X-ray examination particularly for medical examination purposes, hence for inspection of structures that are located e.g. inside a human body. X-ray detectors have been developed in a large variety for various Computer Tomography (CT) applications. X-ray detectors are typically built in a discrete form, consisting of a two dimensional photodiode array and discrete electronics to process electric charge acquired from the photodiode. The processing of the acquired signals allows to visualize structures, tissue and substances located in the bulk of e.g. biologic material.

Signal processing for visualization of acquired data is typically performed on the basis of digital signal processing. Therefore, electric charge that is acquired by an X-ray detector representing an analog signal has to be converted into a corresponding digital signal for the subsequent signal processing. The document U.S. Pat. No. 6,163,029 discloses an X-ray diagnosing apparatus and a corresponding radiation detector. Here, the radiation detector has photoelectric converting means disposed in a matrix for converting radiation impinging through a specimen through electric charge and accumulating the electric charge; reading means for reading the electric charge accumulated in the photoelectric means; a pre-processing circuit for integrating the electric charge read out from the photoelectric means through the reading means to convert to a voltage; an A/D converter for converting an analog voltage signal output from the pre-processing circuit to a digital signal; and a control means for changing a characteristic of the pre-processing circuit depending on a radiation irradiation condition.

Further, U.S. Pat. No. 6,163,029 discloses an X-ray solid flat panel detector that comprises a plurality of photoelectric conversion elements corresponding to each of picture elements disposed, a plurality of thin film transistors (TFT) as a reading switch, disposed corresponding to each of the photoelectric conversion elements, a gate driver for sending a drive signal to gates of the TFTs of each column, a plurality of initial stage integration amplifiers connected commonly to drains of the TFTs of each row, a multiplexer for time-division multiplexing an output of each initial stage integration amplifier, an amplifier for amplifying an output of the multiplexer and an ADC for carrying out analog/digital conversion of an output of the amplifier and outputting to the image memory.

Here, the analog digital conversion takes place after the acquired charges have been subject to readout from photoelectric conversion elements, integration by initial stage integration amplifiers and multiplexing. Hence, an analog/digital conversion takes place outside of the matrix of photoelectric conversion elements and requires analog signal pre-processing as well as analog signal transmission to the external analog digital converter. In particular, when using conventional or cost effective photodiodes as photoelectric conversion elements, a potentially very low output signal has to be amplified and routed to these external signal processing means by making use of e.g. quite long lines and connectors. With respect to performance and integrity aspects of an X-ray detector, it is mandatory to place the readout electronics of the detector as close as possible to the light radiation detection elements in order to minimize noise as well as crosstalk and interference between a plurality of acquired signals. Also, transmission of analog signals is generally much more sensitive to perturbations compared to transmission of digital signals featuring a sequence of pulses of e.g. equal shape.

The present invention therefore aims to provide a radiation sensor featuring signal processing means for performing an analog digital conversion of acquired signals in the same substrate in which the sensing elements are located.

The present invention provides a radiation sensor having a plurality of sensor elements wherein each one of the sensor elements comprises a radiation detection portion that is adapted to generate electric charge in response to impingement of electromagnetic radiation. Further, each one of the sensor elements comprises charge accumulating means that are coupled to the radiation detection portion for accumulating the charge generated by the radiation detection portion and comprises signal generation means for generating a signal, if the accumulated charge reaches a predefined threshold.

Typically, the radiation sensor features a one-dimensional or two- dimensional array of sensor elements, also denoted as pixels representing a smallest discrete radiation detection area of the radiation sensor. According to the invention, each pixel of the radiation sensor has charge accumulating means and signal generation means for generating a sequence of signals that can further be processed as a digital signal. Typically, the frequency of the sequence of signals generated by the signal generation means carries information of the charge being acquired by the radiation detection portion of the sensor element. It is therefore an advantage of the present invention to provide analog to digital conversion for each pixel of a radiation sensor, hence to implement analog to digital conversion means on pixel level.

Consequently, electric charge acquired by each sensor element, i.e. each pixel, is locally converted into a digital signal. Since digital signals are much more robust against external perturbations than analog signals, by confining analog signal transmission and processing within each pixel or sensor element of the radiation sensor, perturbations to analog signals are effectively reduced to a minimum, thus increasing the overall sensitivity and accuracy of the radiation sensor.

In another embodiment, the signal generation means of the radiation sensor comprise a comparator for comparing the accumulated charge with the predefined threshold and a signal generation module for generating a pulsed signal with a predetermined shape in response to receive a flag signal generated by the comparator if the accumulated charge reaches the predefined threshold. The generated pulsed signal typically features a predetermined amplitude as well as a predetermined pulse width. It can therefore be interpreted as a discrete signal of a sequence of signals that are generated when the accumulated charge repeatedly reaches the threshold.

According to a further preferred embodiment of the invention, the radiation sensor comprises a charge feedback mechanism for providing a constant amount of charge to the charge accumulating means in response to a generation of a signal by means of the signal generation means. In this way every time a signal is generated by means of the signal generation means in response of the accumulated charge reaching the predefined charge threshold, the constant amount of charge is provided to the charge accumulating means in order to restore the level of charge accumulation that is beneath the predefined threshold.

In particular, if the charge accumulating means are adapted to accumulate positive charges, the flag signal is generated if the accumulated charges are above the predefined threshold and in the opposite case, when the charge accumulating means are adapted to accumulate negative charges, the flag signal is preferably generated if the level of accumulated charges drops below the predefined threshold. In either case the feedback mechanism provides subtraction or superposition of a fixed amount of charge to the accumulated charges. In case of accumulation of positive electric charge, the feedback mechanism provides subtraction of the constant amount of charge if the comparator detects that the accumulated charges are above the predefined threshold and the signal generation module generates the pulsed signal. Hence, the level of accumulated charges then drops below the predefined threshold and by continuous charge accumulation, the accumulated charge repeatedly reaches a threshold for generation of a subsequent pulsed signal. In this way a digital pulse train can be effectively generated by means of a charge accumulator, a comparator and a signal generation module even within a pixel of the radiation sensor itself.

According to a further preferred embodiment of the invention, the charge accumulating means are adapted to continuously accumulate electric charge. Typically, the charge accumulating means are implemented as a charge integrating device, such as an integrator. Further, by continuously accumulating electric charge generated by the radiation detection portion, radiation detection is by no means subject to a reset. Hence, charge generated in response to impingement of electromagnetic radiation on the radiation detector portion is entirely accumulated by means of the charge accumulating means or by means of the integrator. The integrator or charge accumulating means are therefore implemented as a device not featuring a dead time.

According to a further preferred embodiment of the invention, the comparator is adapted to generate the flag signal in response to the accumulated charge exceeding the predefined threshold or in response to the accumulated charge falling below the predefined threshold. This accounts for the functionality of the radiation detection portion providing negative or positive electric charge in response to electromagnetic radiation impingement. Correspondingly, also the charge accumulating means are adapted to accumulate positive as well as negative electric charge. The charge accumulating means are preferably configured to either accumulate positive or negative electric charge. Also, the integrator representing the charge accumulating means may be configurable to either accumulate positive or negative electric charge.

According to a further preferred embodiment of the invention, the charge accumulating means are further adapted to process a differential signal generated by the radiation detection portion providing photoelectric conversion of incident electromagnetic radiation. Correspondingly, the radiation detection portion or photoelectric conversion part of the sensor element or pixel is also adapted to provide the differential signal that is typically transmitted to the charge accumulating means by means of two separate conductors. In this way, the entire charge accumulation as well as subsequent signal processing can be performed with respect to all benefits provided by differential signal transmission and differential signal processing. For instance, such a differential signal transmission allows for an effective common mode rejection in order to reduce noise and to increase sensitivity of the radiation sensor.

According to a further preferred embodiment of the invention, the predefined threshold used by the signal generation means and in particular by the signal generation module is modifiable and determines a frequency of the generation of the pulsed signal. Assuming that the sensor element is subject to a continuous impingement of electromagnetic radiation, the radiation detection portion generates a current that is provided and whose charge is accumulated by the charge accumulating means. Consequently, the output of the charge accumulating means, i.e. the integrator, constantly rises. Whenever the comparator detects a reaching of the threshold, the flag signal is generated leading to generation of the pulsed signal. By lowering the predefined threshold, the threshold level of accumulated charges is reached within a shorter time interval, thus leading to a repetitive signal generation after a shorter time interval. In a corresponding way, by increasing the threshold, the time interval between two successively generated pulsed signals can be increased.

According to a further preferred embodiment of the invention, the charge accumulating means and the signal generation means, in particular the comparator and the signal generation module, constitute a current to frequency converter and the sensor element represents a pixel of a radiation detection chip that is preferably realized as an integrated circuit. In particular, the magnitude of the current generated by the radiation detection portion of the sensor element determines the charge accumulating rate and thereby governs the time interval between two successively generated pulsed signals. An increase of the current, e.g. due to an increasing intensity of impinging radiation, is therefore directly correlated to shorter pulsed intervals. Hence, the frequency of the generated signals increases as a consequence of an increase of intensity of incident radiation. Consequently, the invention provides a radiation sensor having plurality of pixels, each of which featuring a built-in current to frequency converter.

According to a further preferred embodiment of the invention, the radiation detection portion and/or the charge accumulating means and/or the signal generation means are implemented on the basis of Complementary Metal Oxide Semiconductor technology (CMOS) or similar integrated circuit production processes. Further, these components of the sensor elements are all arranged besides one another on a common substrate. The implementation on the basis of CMOS technology allows for a cost effective realization of the radiation sensor and is suitable for a mass production of radiation sensors and sensor elements.

In another aspect the invention provides a radiation sensor that has a plurality of sensor elements, each of which comprising a photoelectric detection portion providing an electric current in response to impingement of electromagnetic radiation, a current integrator coupled to the photoelectric detection portion for accumulating the charge provided by the electric current, a comparator for comparing charge accumulated by the current integrator with a predefined threshold and a pulse emitter for generating a pulsed signal if the accumulated charge reaches the predefined threshold. In a preferred embodiment, the radiation sensor comprises a two dimensional array of sensor elements, each of which comprising a photoelectric detection portion, a current integrator, a comparator and a pulse emitter according to the present invention.

According to a further preferred embodiment, the photoelectric detection portion is sensitive to X-rays. In that sense, the entire radiation sensor is applicable to X-ray detection and is preferably designed to be integrated into an X-ray examination apparatus for e.g. X-ray examination of biological tissue or non-accessible structures located in a bulk of a medium.

In still another aspect, the invention provides an X-ray examination apparatus that has at least one radiation sensor according to the present invention. The radiation sensor has a plurality of sensor elements, each of which comprising a photoelectric detection portion providing an electric current in response to impingement of electromagnetic radiation, preferably in the X-ray wavelength range, a current integrator coupled to the photoelectric detection portion for accumulating the charge carried by the electric current and a pulse emitter for generating a pulsed signal if the charge accumulated by the current integrator reaches a predefined threshold.

In the following it is to be noted that any reference signs in the claims are not to be construed as limiting the scope of the present invention.

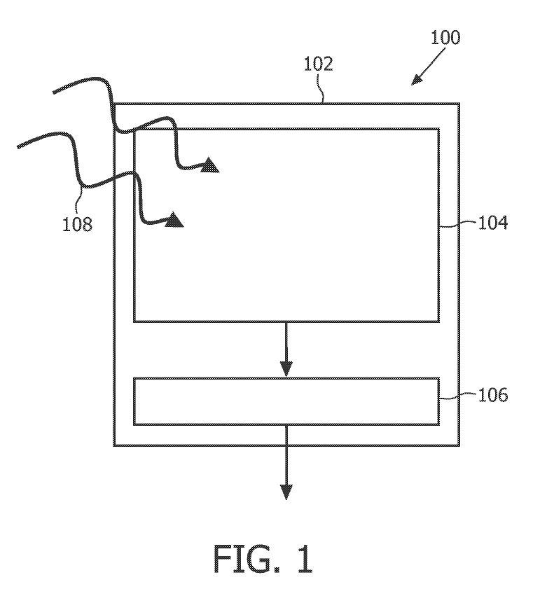

FIG. 1 illustrates a schematic block diagram of the radiation sensor and a sensor element

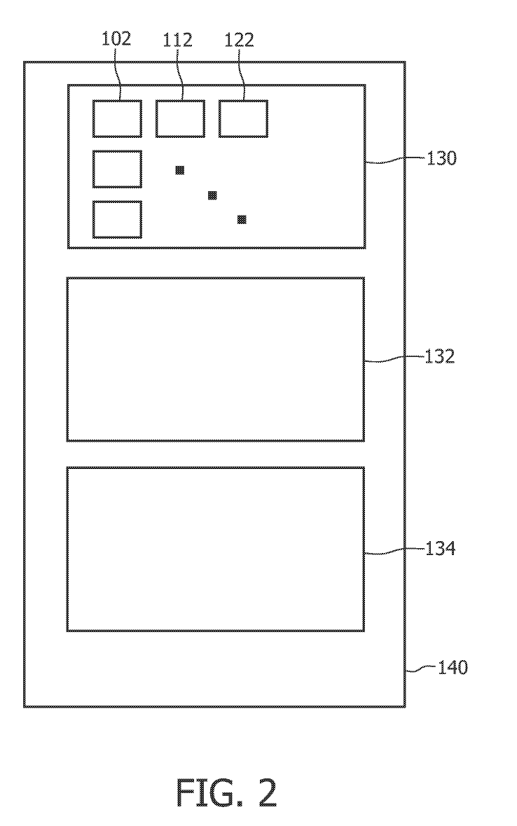

FIG. 2 illustrates a schematic block diagram of a radiation detector having a plurality of radiation sensors, each of which having a plurality of sensor elements,

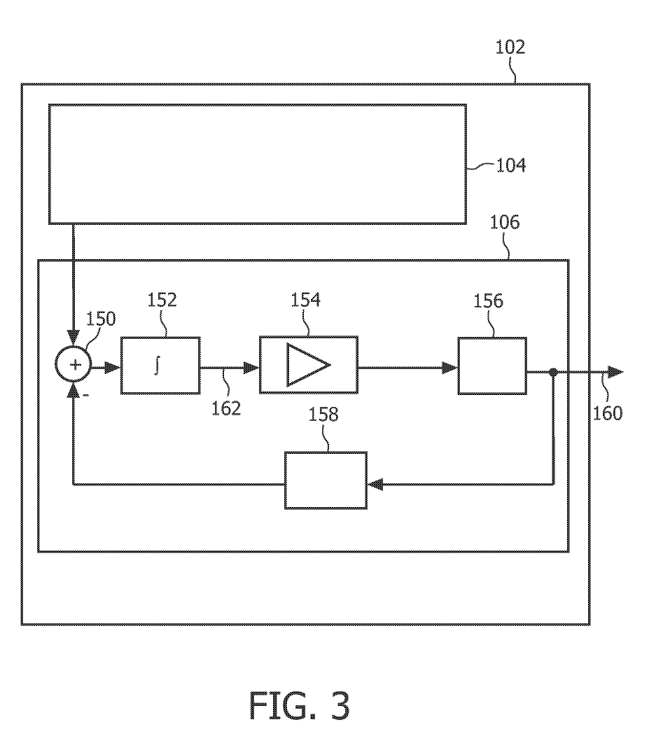

FIG. 3 shows a block diagram of the internal structure of a sensor element,

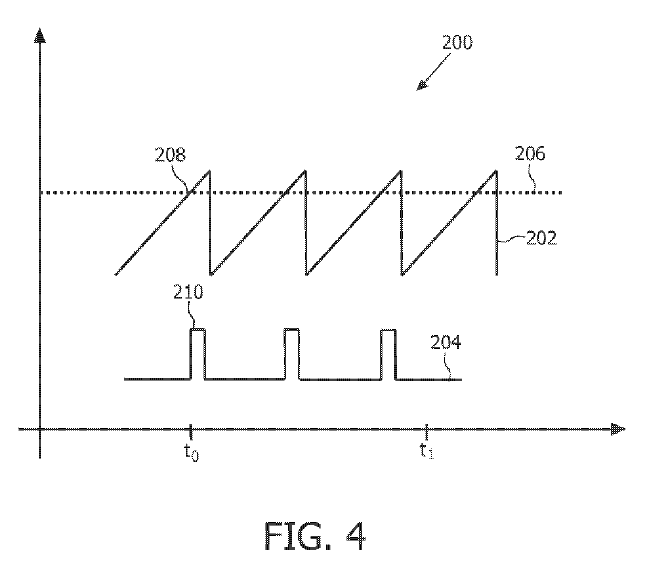

FIG. 4 illustrates a diagram reflecting integrator output and pulsed signal generation.

FIG. 1 shows a schematic block diagram of the radiation sensor 100 that has at least one sensor element 102, which in turn comprises a radiation detection area 104 and a signal processing module 106. The radiation detection area provides an electric current to the signal processing module 106 in response to detection of electromagnetic radiation 108. Typically, the radiation detection area 104 is implemented as a CMOS photodiode providing a current to the signal processing module 106 that represents the intensity of the electromagnetic radiation 108. Typically, the radiation detection area 104 covers the major part of the sensor element 102. The signal processing module 106 is typically arranged besides the radiation detection area and both, radiation detection area 104 and signal processing module 106 are implemented on a common substrate, e.g. by making use of CMOS technology.

The signal processing module 106 typically comprises charge accumulating means as well as signal generation means for converting the current received from the radiation detection area 104 into a pulsed train of discrete and hence digital signals. The signal processing module 106 therefore serves as a pre-processing means as well as analog to digital converting element located in each pixel 102 of a radiation sensor 100. Advantageously, this pre-processing of acquired signals helps to circumvent the problem of transmitting analog signals over appreciable distances to analog signal processing means located outside an array of sensor elements 102 of a radiation sensor 100. By means of this built-in implementation of signal processing module 106 into a pixel 102 of a radiation sensor 100, the overall radiation detection becomes more robust with respect to disturbance, perturbation and noise, because the digital signal generated by the signal processing module 106 is much more insensitive to disturbances of any kind during transmission to image processing means that are adapted to form a visual image of the acquired radiation 108.

FIG. 2 schematically shows a block diagram of a radiation detector 140. Here, the radiation detector 140 has three radiation sensors 130, 132, 134. The internal structure of radiation sensor 130 is exemplary illustrated. Radiation sensor 130 comprises an array of sensor elements 102, 112, 122. . . . Each one of these sensor elements 102, 112, 122 comprises a radiation detection area 104, e.g. a photodiode, as well as a signal processing module 106 as illustrated in FIG. 1. Each one of the sensor elements 102, 112, 122 is adapted to separately generate a digital pulse train in response to impingement of electromagnetic radiation, in particular X-rays. In typical implementations, e.g. in X-ray examination apparatuses, such a radiation detector 140 may have a large amount of radiation sensors, like a few hundreds. These radiation sensors 130, 132, 134 are also denoted as light sensitive—or charge coupled device (CCD) chips. Also, in typical implementations, each radiation sensor 130, 132, 134 may have a large amount of pixels even hundreds or thousands, each of which typically featuring a size in the square millimeters or sub-square millimeter range.

In particular, due to the integrated realization of a photoelectric conversion part and respective pre-processing means on a common substrate by making use of CMOS technology, such a chip 130 can be produced in a cost efficient way in a mass production process.

FIG. 3 shows a block diagram of the internal structure of the sensor element 102 and its signal processing module 106. The signal processing module 106 has an adder 150, an integrator 152, a comparator 154, a pulse generator 156 and a charge feedback module 158. Electromagnetic radiation 108 being incident on the radiation detection area 104 is converted by means of the signal processing module 106 into a pulse train of discrete signals that can be detected at the output port 160 of the sensor element 102.

The adder 150 is adapted to superimpose electric charge provided by the radiation detection area 104 and provided by the charge feedback module 158. The output of the adder 150 is coupled to the input of the integrator 152 that serves to accumulate electric charge provided by the output of the adder. For instance, if the integrator 152 is designed for accumulating positive electric charge, its output 162 provides a rising signal if a constant intensity is incident to the radiation detection area producing a constant current that is coupled to the integrator 152. Such a rising signal generated by the integrator 152 is coupled to the comparator 154 that compares this rising signal with a predefined threshold. In case that the signal reaches the threshold or even exceeds the threshold, the comparator generates a flag signal that is transmitted to the pulse generator 156. In response to receive this flag signal indicating that the predefined threshold level of integrated charge has been reached, the pulse generator module 156 generates a discrete pulsed signal with a predefined amplitude and predefined width.

The output of the pulse generator is coupled to the output port 160 as well as to the charge feedback module 158. The charge feedback module 158 serves to decrease the level of accumulated charges below the threshold. In this way, with a continuous charge accumulation of the integrator 152, the threshold level is repeatedly reached after a certain time interval. Consequently, a successive pulsed signal is generated by the pulse generator 156. Depending on the level of the threshold as well as on the magnitude of the current provided by the radiation detection area 104, the frequency of the pulsed signal generation varies. Keeping the level of the predetermined threshold constant, the frequency of the pulsed signals represents the magnitude of the current produced by the radiation detection area 104.

Coupling the output port 160 of the sensor element 102 to respective digital signal processing means, the frequency of the pulsed signals can be accurately determined for visualization of the acquired electromagnetic radiation. The transmission of the digital signal from the output port 160 to respective digital signal processing means is very robust and insensitive to external perturbations compared to analog signal transmission.

The integrator 152 as well as the radiation detection area 104 and even the comparator 154 may also be implemented as modules that are adapted to process differential signals that are typically transmitted by means of two separate conductors. In such an implementation, common mode components of a current generated by the radiation detection area 104 can be effectively rejected, thus allowing to reduce the overall noise of the output signal of the sensor element 102.

Further, the circuit constituted by the adder 150, the integrator 152, the comparator 154, the signal emitter 156 and the charge feedback module 158 may be clocked by a system clock of the radiation sensor 100 or the radiation detector 140. Also, this circuit constituting a current to frequency converter might be driven in a continuous mode.

FIG. 4 shows a diagram 200 illustrating the temporal evolution of a signal 202 generated by the charge integrator 152. Further, diagram 200 displays a corresponding temporal evolution of the output signal 204 of the pulse generator 156. The threshold 206 is shown as a horizontal line and at the first intersection point 208 corresponding to a time to, a pulse signal 210 is generated. Due to the charge feedback module, 158 the signal 202 drops as the pulse 210 is generated. This feedback mechanism allows to repeatedly reduce the accumulated charges and to enable a repeated rising of the signal 202 until the threshold 206 is repeatedly reached.

The current produced by the radiation detection area 104 is represented in the slope of the integration output signal 202. The higher the current, the higher the slope will be and consequently the time interval between successive generation of pulsed signals will decrease. Hence, an increased current indicating a larger intensity of incident radiation directly leads to a larger frequency of the pulsed output signal 204.

In a corresponding way, the current to frequency converter can also be designed for accumulating negative charges. In this case the slope of the integration output signal 202 is negative and the threshold represents a lower threshold. If the signal then falls below this lower threshold, a corresponding flag signal is generated by the comparator 154 and the pulsed signal 204 is generated in the same way. Depending on the type of photodiode implemented in the radiation detection area 104, the inventive current to frequency converter can be universally adapted to various specifications of the photoelectric conversion part 104 of the sensor element 102 as well as to various specifications of subsequent digital signal processing. For instance, by lowering or rising of the threshold 206, a basic frequency of the pulsed output signal 204 can be arbitrarily modified.

### LIST OF REFERENCE NUMERALS

100 radiation sensor
102 sensor element
104 radiation detection area
106 signal processing module
108 radiation
112 sensor element
122 sensor element
130 radiation sensor
132 radiation sensor
134 radiation sensor
140 radiation detector
150 adder
152 integrator
154 comparator
156 pulse generator
158 charge feedback module
160 output port
162 integration output port
200 diagram
202 integration output signal
204 pulsed output signal
206 threshold
208 intersection point
210 signal pulse

1. A radiation sensor having a plurality of sensor elements, each one of the sensor elements comprising:
a radiation detection portion being adapted to generate electric charge in response to impingement of electromagnetic radiations,
charge accumulating means coupled to the radiation detection portion for accumulating the charge of the radiation detection portion,
signal generation means for generating a signal if the accumulated charge reaches a predefined threshold.

2. The radiation sensor according to claim 1, wherein the signal generation means comprise:
a comparator for comparing the accumulated charge with the predefined threshold,
signal generation module for generating a pulsed signal with a predetermined shape in response to receive a flag signal generated by the comparator if the accumulated charge reaches the predefined threshold.

3. The sensor according to claim 1 further comprising a charge feedback mechanism for providing a constant amount of charge to the charge accumulating means in response to a generation of the signal by means of the signal generation means.

4. The sensor according to claim 1, wherein the charge accumulating means are adapted to continuously accumulate electric charge.

5. The sensor according to claim 2, wherein the comparator is adapted to generate the flag signal in response to the accumulated charge exceeding the predefined threshold or in response to the accumulated charge falling below the predefined threshold and wherein the charge accumulating means are adapted for accumulating positive and negative electric charges.

6. The sensor according to claim 1, wherein the charge accumulating means are further adapted to process a differential signal generated by the radiation detection portion.

7. The sensor according to claim 1, wherein the predefined threshold is modifiable and determines a frequency of the generation of the signal.

8. The sensor according to claim 1, wherein the charge accumulating means and the signal generation means constitute a current to frequency converter and wherein the sensor element represents a pixel of a radiation detection chip.

9. The sensor according to claim 1, wherein the radiation detection portion and/or the charge accumulating means and/or the signal generation means are implemented on the basis of Complementary Metal Oxide Semiconductor technology and are arranged besides one another on a common substrate.

10. A radiation sensor having a plurality of sensor elements, each one of the sensor elements comprising:
a photoelectric detection portion providing an electric current in response to impingement of electromagnetic radiation,
a current integrator coupled to the photoelectric detection portion for accumulating the charge provided by the electric current,
a comparator for comparing charge accumulated by the current integrator with a predefined threshold,
a pulse emitter for generating a pulsed signal if the accumulated charge reaches the predefined threshold.

11. The radiation sensor according to claim 10, further comprising a two-dimensional array of sensor elements each of which comprising a photoelectric detection portion, a current integrator, a comparator and a pulse emitter.

12. The radiation sensor according to claim 10, wherein the photoelectric detection portion is sensitive to X-rays.

13. The radiation sensor according to claim 10, wherein the current integrator, the comparator and the pulse emitter constitute a current to frequency converter.

14. An X-ray examination apparatus having at least one radiation sensor having a plurality of sensor elements, each sensor element comprising:
a photoelectric detection portion providing an electric current in response to impingement of electromagnetic radiation,
a current integrator coupled to the photoelectric detection portion for accumulating the charge carried by the electric current,
a pulse emitter for generating a pulsed signal if the charge accumulated by the current integrator reaches a predefined threshold.
